(19) United States
(12) Patent Application Publication
(10) Pub. No.: US 2026/0057825 A1
(43) Pub. Date: Feb. 26, 2026

(54) DISPLAY PANEL AND DISPLAY DEVICE

(71) Applicant: Wuhan Tianma Microelectronics Co., Ltd., Wuhan (CN)

(72) Inventors: Shuai ZHENG, Wuhan (CN); Maoqing ZHOU, Wuhan (CN)

(73) Assignee: Wuhan Tianma Microelectronics Co., Ltd., Wuhan (CN)

(21) Appl. No.: 19/378,944

(22) Filed: Nov. 4, 2025

(30) Foreign Application Priority Data
Aug. 12, 2025 (CN) 202511128886.2

(51) Int. Cl. G09G 3/32

(52) U.S. Cl. CPC G09G 3/32; G09G 2300/043; G09G 2300/0819; G09G 2310/08; G09G 2320/0233; G09G 2320/0247; G09G 2320/045

(57) ABSTRACT

Provided are a display panel and a display device. The display panel comprises a pixel circuit and a light-emitting element. In the pixel circuit, a gate of a driving transistor is electrically connected to a first node, and a first electrode of the driving transistor is electrically connected to a second node. A bias adjustment module comprises a bias transistor, a gate of the bias transistor is electrically connected to a first scanning terminal, and the bias transistor is electrically connected between a first signal terminal and a fourth node. The first signal terminal is configured to provide a first bias signal. A first capacitor is electrically connected between the fourth node and the first node. A control terminal of a threshold compensation module is electrically connected to a second scanning terminal.

### CROSS-REFERENCE TO RELATED APPLICATION(S)

This application claims priority to Chinese Patent Application No. 202511128886.2 filed Aug. 12, 2025, the disclosure of which is incorporated herein by reference in its entirety.

### TECHNICAL FIELD

The present disclosure relates to the field of display, and in particular to a display panel and a display device.

### BACKGROUND

In a display panel, the pixel circuit provides a driving current required for the light-emitting element of the display panel to display and controls whether the light-emitting element enters a light emission stage. Therefore, the pixel circuit is an indispensable element in the display panel.

At present, as the service time of the display panel increases, the characteristic of a driving transistor in the pixel circuit may change slowly, causing the threshold voltage of the driving transistor to drift, thereby affecting display effect of the display panel.

### SUMMARY

The present disclosure provides a display panel and a display device to solve the problem of the drift of the threshold voltage of the driving transistor in the existing display panel.

According to an aspect of the present disclosure, a display panel is provided, and the display panel includes a pixel circuit and a light-emitting element.

The pixel circuit includes a driving transistor, a bias adjustment module, a threshold compensation module and a first capacitor.

A gate of the driving transistor is electrically connected to a first node, a first electrode of the driving transistor is electrically connected to a second node, a second electrode of the driving transistor is electrically connected to a third node, the second node is electrically connected to a first power terminal, and the third node is electrically connected to the light-emitting element.

The bias adjustment module includes a bias transistor, a gate of the bias transistor is electrically connected to a first scanning terminal, and the bias transistor is electrically connected between a first signal terminal and a fourth node. The first capacitor is electrically connected between the fourth node and the first node. The first signal terminal is configured to provide a first bias signal.

A control terminal of the threshold compensation module is electrically connected to a second scanning terminal, and the threshold compensation module is electrically connected between the first node and the third node or between the first node and the second node.

According to another aspect of the present disclosure, a display device is provided, and the display device includes the display panel as described above.

It should be understood that the content described in this section is not intended to identify the key or important features of the embodiments of the present disclosure, nor is it intended to limit the scope of the disclosure. Other features of the present disclosure will be clear from the following description.

### BRIEF DESCRIPTION OF DRAWINGS

To illustrate the solutions in the embodiment of the present disclosure more clearly, the embodiment is described hereinafter through description in conjunction with the drawings. Apparently, the drawings described herein are part of the embodiments of the present application, and based on the drawings of the present application, all other drawings may be obtained by those of ordinary skill in the art on the premise that no creative work is done.

FIG. 1 is a schematic diagram of a display panel provided by an embodiment of the present disclosure.

FIG. 2 is a schematic diagram of a pixel circuit provided by an embodiment of the present disclosure.

FIG. 3 is a schematic diagram of another pixel circuit provided by an embodiment of the present disclosure.

FIG. 4 is a working timing diagram of the pixel circuit shown in FIG. 2.

FIG. 5 is a working timing diagram of the pixel circuit shown in FIG. 3.

FIG. 6 is a schematic diagram of another pixel circuit provided by an embodiment of the present disclosure.

FIG. 7 is a working timing diagram of the pixel circuit shown in FIG. 6.

FIG. 8 is a schematic diagram of another pixel circuit provided by an embodiment of the present disclosure.

FIG. 9 is a working timing diagram of the pixel circuit shown in FIG. 8.

FIG. 10 is a schematic diagram of another pixel circuit provided by an embodiment of the present disclosure.

FIG. 11 is a schematic diagram of another display panel provided by an embodiment of the present disclosure.

FIG. 12 is a schematic diagram of another display panel provided by an embodiment of the present disclosure.

FIG. 13 is a schematic diagram of another display panel provided by an embodiment of the present disclosure.

FIG. 14 is a schematic diagram of another display panel provided by an embodiment of the present disclosure.

FIG. 15 is a schematic diagram of another display panel provided by an embodiment of the present disclosure.

FIG. 16 is a schematic diagram of another display panel provided by an embodiment of the present disclosure.

FIG. 17 is a schematic diagram of another display panel provided by an embodiment of the present disclosure.

FIG. 18 is a schematic diagram of another display panel provided by an embodiment of the present disclosure.

FIG. 19 is a schematic diagram of another display panel provided by an embodiment of the present disclosure.

FIG. 20 is a schematic diagram of a display device provided by an embodiment of the present disclosure.

### DETAILED DESCRIPTION

To enable those skilled in the art to better understand the solutions of the present disclosure, the solutions in the embodiments of the present disclosure are described clearly and completely hereinafter in conjunction with the drawings in the embodiments of the present application. Apparently, the embodiments described herein are only part of the embodiments of the present disclosure, but not all of the embodiments, and based on the embodiments of the present application, all other embodiments obtained by those of ordinary skill in the art on the premise that no creative work is done are within the scope of the present application.

It should be noted that the terms “first” and “second” in the description, claims and the above drawings of the present disclosure are used to distinguish similar objects, and are not necessarily used to describe a specific order or sequence. It should be understood that the numbers used in this way may be interchanged where appropriate, so that the embodiments of the present disclosure described herein may be implemented in an order other than those illustrated or described herein. Furthermore, the terms “including” and “comprising” and any variations thereof are intended to cover non-exclusive inclusion, for example, a process, method, system, product or device that includes a series of steps or elements is not necessarily limited to those steps or elements expressly listed, but may include other steps or elements not expressly listed or inherent to such process, method, product or device.

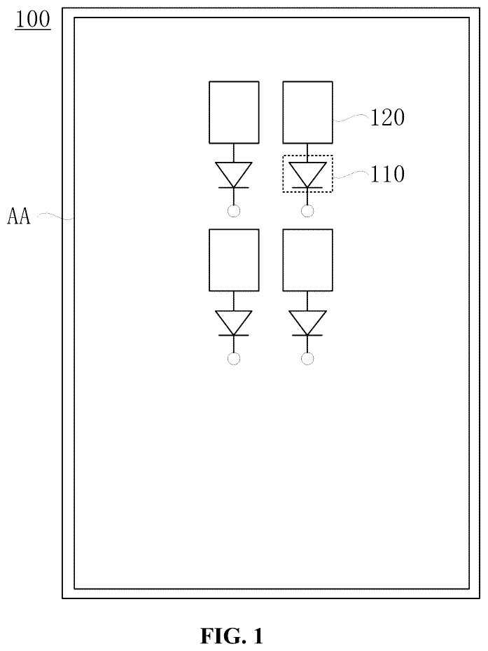

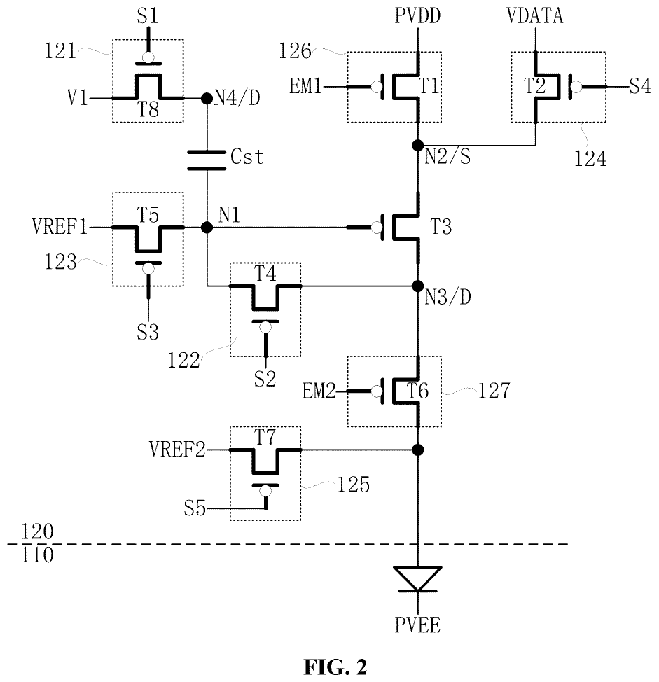

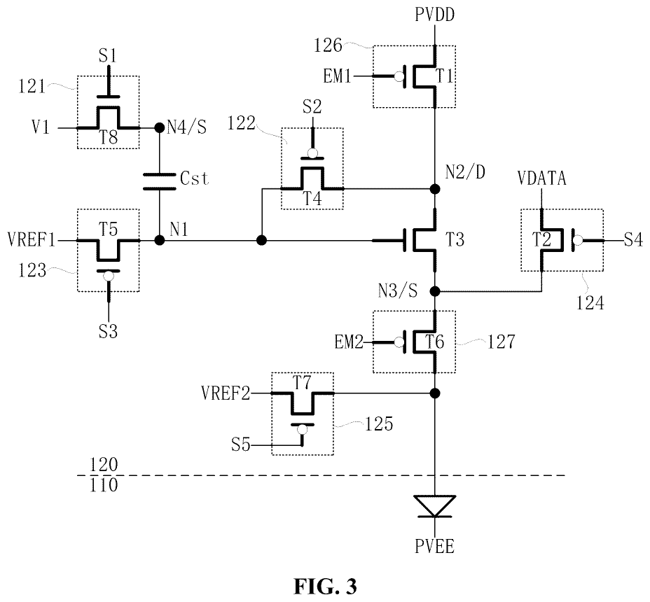

FIG. 1 is a schematic diagram of a display panel provided by an embodiment of the present disclosure. FIG. 2 is a schematic diagram of a pixel circuit provided by an embodiment of the present disclosure. FIG. 3 is a schematic diagram of another pixel circuit provided by an embodiment of the present disclosure. Referring to FIGS. 1 to 3, the display panel 100 provided by an embodiment of the present disclosure includes a light-emitting element 110 and a pixel circuit 120. The pixel circuit 120 includes a driving transistor T3, a bias adjustment module 121, a threshold compensation module 122 and a first capacitor Cst. A gate of the driving transistor T3 is electrically connected to a first node N1, a first electrode of the driving transistor T3 is electrically connected to a second node N2, a second electrode of the driving transistor T3 is electrically connected to a third node N3, the second node N2 is electrically connected to a first power terminal PVDD, and the third node N3 is electrically connected to the light-emitting element 110. The bias adjustment module 121 includes a bias transistor T8, a gate of bias transistor T8 is electrically connected to a first scanning terminal S1, and the bias transistor T8 is electrically connected between a first signal terminal V1 and a fourth node N4. The first signal terminal V1 is configured to provide a first bias signal. The first capacitor Cst is electrically connected between the fourth node N4 and the first node N1. A control terminal of the threshold compensation module 122 is electrically connected to a second scanning terminal S2, and the threshold compensation module 122 is electrically connected between the first node N1 and the third node N3 or between the first node N1 and the second node N2. In one or more embodiments, as shown in FIG. 2, the driving transistor T3 is a P-type transistor, i.e., P-metal-oxide-semiconductor (PMOS), and the threshold compensation module 122 is electrically connected between the first node N1 and the third node N3. In one or more embodiments, as shown in FIG. 3, the driving transistor T3 is an N-type transistor, i.e., N-metal-oxide-semiconductor (NMOS), and the threshold compensation module 122 is electrically connected between the first node N1 and the second node N2. In the embodiments of the present disclosure, “electrically connected” may refer to either directly electrically connected or electrically connected through other components.

In the present embodiment, the display panel includes multiple light-emitting elements 110 and multiple pixel circuits 120. The pixel circuits 120 are electrically connected to the light-emitting elements 110 for driving the light-emitting elements 110 and ensuring the light emission and display of the light-emitting elements 110.

The pixel circuit 120 includes the driving transistor T3, the gate of the driving transistor T3 is electrically connected to the first node N1, the first electrode of the driving transistor T3 is electrically connected to the second node N2, the second electrode of the driving transistor T3 is electrically connected to the third node N3, the second node N2 is electrically connected to the first power terminal PVDD, and the third node N3 is electrically connected to the light-emitting element 110. In one or more embodiments, the first power terminal PVDD is configured to provide a first power signal, and the third node N3 is electrically connected to an anode of the light-emitting element 110. Referring to FIG. 2, the driving transistor T3 is a P-type transistor, i.e., PMOS. The first electrode of the driving transistor T3, as the source S, is electrically connected to the second node N2, and the second electrode of the driving transistor T3, as the drain D, is electrically connected to the third node N3. Referring to FIG. 3, the driving transistor T3 is an N-type transistor, i.e., NMOS. The first electrode of the driving transistor T3, as the drain D, is electrically connected to the second node N2, and the second electrode of the driving transistor T3, as the source S, is electrically connected to the third node N3. It can be understood that the source and the drain of a transistor are not fixed, but may be changed with the driving state of the transistor.

The potential at the first node N1 is switched between a high level and a low level, thereby controlling an on or off state of the driving transistor T3. When the potential at the first node N1 controls the driving transistor T3 to be turned on, the transmission path between the first electrode of the driving transistor T3 and the second electrode of the driving transistor T3 is in an on state, and the driving transistor T3 provides a driving current for the light-emitting element 110. When the potential at the first node N1 controls the driving transistor T3 to be turned off, the transmission path between the first electrode of the driving transistor T3 and the second electrode of the driving transistor T3 is in an off state. By controlling the on or off state of the driving transistor T3, the magnitude of the driving current provided to the light-emitting element 110 may be controlled.

The pixel circuit 120 includes the threshold compensation module 122, and the control terminal of the threshold compensation module 122 is electrically connected to the second scanning terminal S2. In one or more embodiments, the second scanning terminal S2 is configured to provide a second scanning signal, and the second scanning signal provided by the second scanning terminal S2 is switched between a high level and a low level to control an on or off state of the threshold compensation module 122. In one or more embodiments, the threshold compensation module 122 includes a threshold compensation transistor T4.

Taking FIG. 2 as an example, the threshold compensation module 122 is electrically connected between the first node N1 and the third node N3. When a potential of the second scanning terminal S2 controls the threshold compensation module 122 to be turned on, the transmission path between the first node N1 and the third node N3 is in an on state so that a voltage between the gate and the second electrode (drain D) of the driving transistor T3 can be adjusted and the threshold voltage of the driving transistor T3 can be compensated. When the potential of the second scanning terminal S2 controls the threshold compensation module 122 to be turned off, the transmission path between the first node N1 and the third node N3 is in an off state. By controlling the on or off state of the threshold compensation module 122, the potential of the gate of the driving transistor T3 can be adjusted, and the threshold voltage of the driving transistor T3 can be compensated.

Taking FIG. 3 as an example, the threshold compensation module 122 is electrically connected between the first node N1 and the second node N2. When the potential of the second scanning terminal S2 controls the threshold compensation module 122 to be turned on, the transmission path between the first node N1 and the second node N2 is in an on state so that the voltage between the gate and the first electrode (drain D) of the driving transistor T3 can be adjusted and the threshold voltage of the driving transistor T3 can be compensated. When the potential of the second scanning terminal S2 controls the threshold compensation module 122 to be turned off, the transmission path between the first node N1 and the second node N2 is in an off state. By controlling the on or off state of the threshold compensation module 122, the potential of the gate of the driving transistor T3 can be adjusted, and the threshold voltage of the driving transistor T3 can be compensated.

The pixel circuit 120 includes the bias adjustment module 121 and the first capacitor Cst. The bias adjustment module 121 includes the bias transistor T8, the gate of the bias transistor T8 is electrically connected to the first scanning terminal S1, and the bias transistor T8 is electrically connected between the first signal terminal V1 and the fourth node N4. The first capacitor Cst is electrically connected between the fourth node N4 and the first node N1. In one or more embodiments, the first scanning terminal S1 is configured to provide a first scanning signal, and the first signal terminal V1 is configured to provide the first bias signal. The first scanning signal provided by the first scanning terminal S1 is switched between a high level and a low level to control an on or off state of the bias transistor T8. When the potential of the first scanning terminal S1 controls the bias transistor T8 to be turned on, the first bias signal provided by the first signal terminal V1 is transmitted to the fourth node N4 through the bias transistor T8. When the potential of the first scanning terminal S1 controls the bias transistor T8 to be turned off, the transmission path between the first signal terminal V1 and the fourth node N4 is in an off state, and the fourth node N4 is floating. By controlling the on or off state of the bias transistor T8, the potential at the fourth node N4 can be adjusted, so that the potential at the first node N1 is coupled through the first capacitor Cst to adjust the potential of the gate of the driving transistor T3.

The bias transistor T8 can play the role of bias adjustment. When the bias transistor T8 is turned on, the first bias signal provided by the first signal terminal V1 is transmitted to the fourth node N4 through the bias transistor T8, and then coupled the first capacitor Cst to adjust the potential of the gate of the driving transistor T3, so that the bias adjustment of the driving transistor T3 can be implemented, the operation stability of the driving transistor T3 can be improved, the drift of the threshold voltage of the driving transistor T3 can be reduced, and the bias level of the driving transistor T3 can be educed. The bias of the driving transistor T3 is caused by many factors, for example, the gate of the driving transistor T3 operates in a forward bias state for a long time, resulting in a forward bias of the threshold voltage Vth, and/or the illumination and the temperature caused by long-term lighting of the light-emitting element 110 causes the voltage of the gate of the driving transistor T3 to rise, resulting in a forward bias of the threshold voltage Vth of the driving transistor T3. Based on the above technical issues, the bias transistor T8 added in the present embodiment can reduce the bias level of the driving transistor T3 and reduce the influence of external factors such as the illumination and the temperature on the voltage of the gate of the driving transistor T3 under long-term operation, thus improving the stability of the working state of the driving transistor T3, further improving the stability of the driving current provided by the driving transistor T3 for the light-emitting element 110, alleviating the low-frequency flicker, improving the display uniformity of the display panel, and thus improving the image display effect of the display panel. The first bias signal provided by the first signal terminal V1 may be monitored in real time and flexibly adjusted.

It should be noted that FIGS. 1 to 3 merely schematically illustrate the key structures of the above embodiments and do not include the entire structure of the circuit operation. Other structures of the circuit are gradually illustrated hereinafter in conjunction with the description of the embodiments of the present disclosure. The pixel circuit 120 has an 8T1C structure, where “T” represents the transistor and “C” represents the capacitor.

In one or more embodiments, the pixel circuit 120 includes a first reset module 123. The first reset module 123 includes a first reset transistor T5, a gate of first reset transistor T5 is electrically connected to a third scanning terminal S3, and the first reset transistor T5 is electrically connected between a first reset signal terminal VREF1 and the first node N1. In one or more embodiments, the third scanning terminal S3 is configured to provide a third scanning signal, and the first reset signal terminal VREF1 is configured to provide a first reset signal. The third scanning signal provided by the third scanning terminal S3 is switched between a high level and a low level to control an on or off state of the first reset transistor T5. When the potential of the third scanning terminal S3 controls the first reset transistor T5 to be turned on, the first reset signal provided by the first reset signal terminal VREF1 is transmitted to the first node N1 to reset the gate of the driving transistor T3. When the potential of the third scanning terminal S3 controls the first reset transistor T5 to be turned off, the transmission path between the first reset signal terminal VREF1 and the first node N1 is in an off state. By controlling an on or off state of the first reset transistor T5, the potential at the first node N1 can be adjusted, and the gate of the driving transistor T3 can be selectively reset.

In one or more embodiments, the pixel circuit 120 includes a data write module 124. The data write module 124 includes a data write transistor T2, and a gate of the data write transistor T2 is electrically connected to a fourth scanning terminal S4. In one or more embodiments, the fourth scanning terminal S4 is configured to provide a fourth scanning signal, and a data signal terminal VDATA is configured to provide a data signal. The fourth scanning signal provided by the fourth scanning terminal S4 is switched between a high level and a low level to control an on or off state of the data write transistor T2. As shown in FIG. 2, the data write transistor T2 is electrically connected between the data signal terminal VDATA and the second node N2. As shown in FIG. 3, the data write transistor T2 is electrically connected between the data signal terminal VDATA and the third node N3. When the potential of the fourth scanning terminal S4 controls the data write transistor T2 to be turned on, the data signal provided by the data signal terminal VDATA is transmitted to the second node N2 so that data is written to the pixel circuit 120. When the potential of the fourth scanning terminal S4 controls the data write transistor T2 to be turned off, the transmission path between the data signal terminal VDATA and the second node N2 is in an off state. By controlling an on or off state of the data write transistor T2, the data is written to the pixel circuit 120.

In one or more embodiments, the pixel circuit 120 includes an anode reset module 125. The anode reset module 125 includes an anode reset transistor T7, a gate of anode reset transistor T7 is electrically connected to a fifth scanning terminal S5, and the anode reset transistor T7 is electrically connected between a second reset signal terminal VREF2 and a first electrode of the light-emitting element 110. In one or more embodiments, the fifth scanning terminal S5 is configured to provide a fifth scanning signal, and the second reset signal terminal VREF2 is configured to provide a second reset signal. The first electrode of the light-emitting element 110 is the anode of the light-emitting element 110. The fifth scanning signal provided by the fifth scanning terminal S5 is switched between a high level and a low level to control an on or off state of the anode reset transistor T7. When the potential of the fifth scanning terminal S5 controls the anode reset transistor T7 to be turned on, the second reset signal provided by the second reset signal terminal VREF2 is transmitted to the anode of the light-emitting element 110 so that the first electrode of the light-emitting element 110 is reset. When the potential of the fifth scanning terminal S5 controls the anode reset transistor T7 to be turned off, the transmission path between the second reset signal terminal VREF2 and the anode of the light-emitting element 110 is in an off state. By controlling the on or off state of the anode reset transistor T7, the reset adjustment of the light-emitting element 110 can be implemented.

In one or more embodiments, the pixel circuit 120 includes a first dimming module 126 and a second dimming module 127. The first dimming module 126 is electrically connected between the first power terminal PVDD and the second node N2. A control terminal of the first dimming module 126 is electrically connected to a first dimming control terminal EM1. The first dimming module 126 includes a first dimming transistor T1. The second dimming module 127 is electrically connected between the third node N3 and the first electrode of the light-emitting element 110. A control terminal of the second dimming module 127 is electrically connected to a second dimming control terminal EM2. The second dimming module 127 includes a second dimming transistor T6. A second electrode of the light-emitting element 110 is electrically connected to a second power terminal PVEE. In one or more embodiments, the first dimming control terminal EM1 is configured to provide a first dimming control signal, and the second dimming control terminal EM2 is configured to provide a second dimming control signal. In one or more embodiments, the first dimming control signal is the same as the second dimming control signal. In some other embodiments, the first dimming control signal is different from the second dimming control signal. The first power signal provided by the first power terminal PVDD is different from a second power signal provided by the second power terminal PVEE. In one or more embodiments, the first power signal is greater than the second power signal. For example, the first power signal is a potential of +15 V, and the second power signal is GND. In one or more embodiments, when the first dimming transistor T1 and the second dimming transistor T6 are turned on, the first power signal flows through the driving transistor T3, and the driving current for the light-emitting element 110 is provided by the driving transistor T3, enabling the light-emitting element 110 to emit light and display.

As described above, the pixel circuit 120 includes at least eight transistors labeled as T1 to T8. The types of transistors in the pixel circuit 120 are diverse, and may be at least one of indium gallium zinc oxide (IGZO) transistors or low temperature poly-silicon (LTPS) transistors. The indium gallium zinc oxide transistors have advantages such as high mobility, good uniformity, simple fabrication process, low leakage current, low hysteresis effect, and suitability for large-scale display products, while the low temperature poly-silicon transistors have advantages such as high switching speed, high carrier mobility and low power consumption.

In one or more embodiments, as shown in FIG. 2, the eight transistors T1 to T8 of the pixel circuit 120 are each the PMOS, and the PMOS may be the low-temperature poly-silicon transistor.

In one or more embodiments, as shown in FIG. 3, the eight transistors T1 to T8 of the pixel circuit 120 include the PMOS and the NMOS, where the PMOS may be the low-temperature poly-silicon transistor and the NMOS may be the indium gallium zinc oxide transistor. In one or more embodiments, the driving transistor T3 and the bias transistor T8 are each the NMOS, specifically, the IGZO transistor, to facilitate the improvement in the potential stability of the driving transistor T3 and the bias transistor T8.

In some other embodiments, the multiple transistors of the pixel circuit are each the NMOS. However, it can be understood that the related practitioner may select the appropriate transistor types for the pixel circuit based on product requirements.

For the PMOS, the turned-on potential received by the gate of the PMOS is a low level, while the turned-off potential is a high level. For the NMOS, the turned-on potential received by the gate of the NMOS is a high level, while the turned-off potential is a low level.

In the present embodiment, during operation of the display panel, the pixel circuit 120 includes multiple driving cycles. In one frame time of the display panel, the pixel circuit 120 includes at least one driving cycle. The driving cycle includes a pre-stage and a light emission stage. For example, if the display panel is in a low-frequency refresh mode, the driving cycle of the pixel circuit 120 further includes a light emission maintaining stage. In other embodiments, if the display panel is in a high-frequency refresh mode, the driving cycle of the pixel circuit may merely include the pre-stage and the light emission stage.

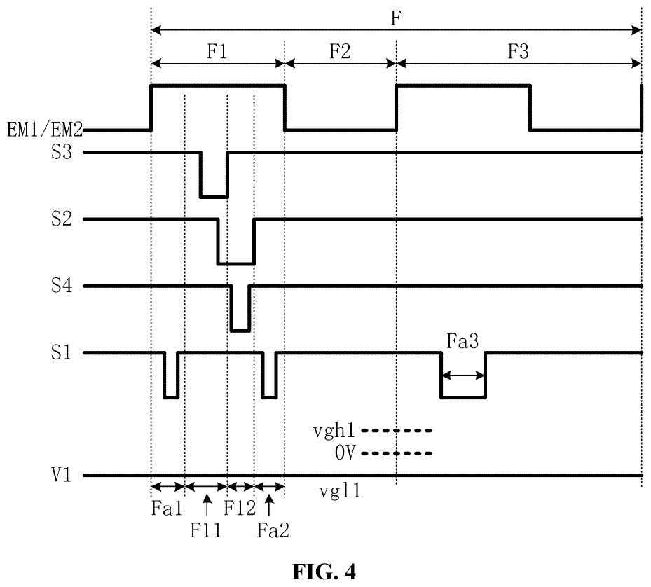

Taking the pixel circuit shown in FIG. 2 as an example, FIG. 4 is a working timing diagram of the pixel circuit shown in FIG. 2. Referring to FIGS. 2 and 4, the pixel circuit 120 includes at least one driving cycle F within at least one frame time of the display panel, and the driving cycle F includes a pre-stage F1, a light emission stage F2 and a light emission maintaining stage F3. The pre-stage F1 includes at least a bias adjustment stage Fa, an initialization stage F11, and a data write stage F12.

In one or more embodiments, the bias adjustment stage Fa includes at least one of a bias adjustment stage Fa1, a bias adjustment stage Fa2, or a bias adjustment stage Fa3. Exemplarily, the pre-stage F1 includes the bias adjustment stage Fa1 and the data write stage F12 which are executed sequentially. Alternatively, the pre-stage F1 includes the data write stage F12 and the bias adjustment stage Fa2 which are executed sequentially. Alternatively, the bias adjustment stage Fa3 may be performed during the pre-stage of the light emission maintaining stage F3. Alternatively, the bias adjustment stage Fa includes a first bias sub-stage Fa1 and a second bias sub-stage Fa2 which are executed with an interval between the first bias sub-stage and the second bias sub-stage. In one or more embodiments, during the pre-stage F1, the data write stage F12 is between the first bias sub-stage Fa1 and the second bias sub-stage Fa2.

Here, the bias adjustment process of the bias adjustment stage Fa1 is merely taken as an example. The working process of the pre-stage F1 of the pixel circuit 120 is as follows:

During the bias adjustment stage Fa1, the bias transistor T8 is turned on. The second scanning terminal S2 provides a high-level signal to turn off the threshold compensation transistor T4. The third scanning terminal S3 is configured to provide a high-level signal to turn off the first reset transistor T5. The first scanning terminal S1 provides a low-level signal to turn on the bias transistor T8. The first bias signal provided by the first signal terminal V1 is written to the fourth node N4, and the potential at the first node N1 is adjusted through the first capacitor Cst to adjust the bias state of the driving transistor T3.

During the initialization stage F11, the third scanning terminal S3 provides a low-level signal to turn on the first reset transistor T5, and the first reset signal provided by the first reset signal terminal VREF1 adjusts the gate of the driving transistor T3 through the first reset transistor T5. If the threshold compensation transistor T4 is also turned on during a later stage, the potential at the third node N3 may also be adjusted by the first reset signal through the first reset transistor T5 and the threshold compensation transistor T4.

During the data write stage F12, the bias adjustment module 121 is turned off, and the data write module 124 is turned on. The fourth scanning terminal S4 provides a low-level signal to turn on the data write transistor T2, and the threshold compensation transistor T4 and the driving transistor T3 are turned on, such that the data signal provided by the data signal terminal VDATA is sequentially transmitted to the gate of the driving transistor T3 to realize data write.

Furthermore, in one or more embodiments, the bias transistor T8 is a double-gate transistor. The bias transistor T8 may be a single-gate transistor or a double-gate transistor. When the bias transistor T8 is a double-gate transistor, the leakage current of the transistor can be reduced and the display effect of the display panel can be improved. Other transistors in the pixel circuit 120 may be single-gate transistors or double-gate transistors as required by the product.

Furthermore, in one or more embodiments, the width-to-length ratio of the bias transistor T8 is a first value. The width-to-length ratio of the driving transistor T3 is a second value. A difference between the first value and the second value is less than or equal to a preset difference. In one or more embodiments, the width-to-length ratio of the bias transistor T8 is a first value, the threshold compensation module 122 includes the threshold compensation transistor T4, the width-to-length ratio of the threshold compensation transistor T4 is a third value, and the first value is less than the third value. In one or more embodiments, the width-to-length ratio of the driving transistor T3 is a second value, the threshold compensation module 122 includes the threshold compensation transistor T4, the width-to-length ratio of the threshold compensation transistor T4 is a third value, and the second value is less than the third value. In one or more embodiments, the width of the gate of the bias transistor T8 is Wa, the length of the gate of the bias transistor T8 is La, the threshold compensation module 122 includes the threshold compensation transistor T4, the width of the gate of the threshold compensation transistor T4 is Wb, the length of the gate of the threshold compensation transistor T4 is Lb, and Wa≥Wb, and/or La≥Lb.

That is, the width-to-length ratio of the bias transistor T8 may be the same as or close to the width-to-length ratio of the driving transistor T3. The width-to-length ratio of the bias transistor T8 may be smaller than the width-to-length ratio of the threshold compensation transistor T4. The width-to-length ratio of the driving transistor T3 may be smaller than the width-to-length ratio of the threshold compensation transistor T4. For example, the width-to-length ratio of the bias transistor T8 may be 3:19, and the width-to-length ratio of the threshold compensation transistor T4 may be 2:6. By properly designing the width-to-length ratio of each transistor in the pixel circuit 120, the bias adjustment of the driving transistor T3 can be realized through the pixel circuit 120 so that the drift of the threshold voltage of the driving transistor caused by the illumination and temperature in the related art can be alleviated. The long-time lighting of the light-emitting element 110 may cause the bias of the threshold compensation transistor T4 and the driving transistor T3. In the present embodiment, by properly designing the width-to-length ratios of the bias transistor T8, the threshold compensation transistor T4 and the driving transistor T3, the voltage of the gate of the driving transistor T3 can be adjusted by the bias transistor T8 during the bias adjustment stage, and the variation of the voltage of the gate of the driving transistor T3 caused by the bias of the threshold compensation transistor T4 and the driving transistor T3 can be offset.

In the present disclosure, the pixel circuit includes the driving transistor, the threshold compensation module, the bias adjustment module, and the first capacitor. The gate of the driving transistor is electrically connected to the first node, the bias adjustment module includes the bias transistor, the gate of the bias transistor is electrically connected to the first scanning terminal, and the bias transistor is electrically connected between the first signal terminal and the fourth node. The first capacitor is electrically connected between the fourth node and the first node. The threshold compensation module is electrically connected between the first node and the third node or between the first node and the second node. In the present disclosure, the bias transistor can play a role in bias adjustment. During the bias adjustment stage, the bias transistor is turned on, the first bias signal provided by the first signal terminal is transmitted to the fourth node through the bias transistor, and then the potential of the gate of the driving transistor is adjusted through the first capacitor in a coupling manner, enabling the adjustment on the bias state of the driving transistor, thereby reducing or even eliminating the variation of the potential of the gate of the driving transistor caused by the bias, and reducing the influence of external factors such as the illumination and the temperature on the bias of the driving transistor under long-term operation. The operation stability and gate voltage stability of the driving transistor can be improved, and the drift of the threshold voltage of the driving transistor can be reduced, thereby improving the stability of the driving current provided by the driving transistor for the light-emitting element, and further improving the display uniformity of the display panel and the image display effect of the display panel.

In one or more embodiments, as shown in FIG. 2, the driving transistor T3 is the PMOS, and the potential of the first bias signal is smaller than the potential at the fourth node N4. Alternatively, the driving transistor T3 is the PMOS, and the potential of the first bias signal is less than 0 V.

The working process of the pixel circuit 120 includes the light emission stage. During the light emission stage, the driving transistor T3 is in the on state, and the driving transistor T3 provides the driving current for the light-emitting element 110, enabling the light-emitting element 110 to emit light.

For the driving transistor T3 being the PMOS, when the driving transistor T3 is in the on state, the potential of the gate of the driving transistor T3 is smaller than the potential of the source of the driving transistor T3. In terms of the driving transistor T3 being the PMOS, the potential of the gate of the driving transistor T3 is equal to the potential at the first node N1, the potential of the source of the driving transistor T3 is equal to the potential at the second node N2, and the potential of the drain of the driving transistor T3 is equal to the potential at the third node N3. During the light emission stage, a forward bias occurs in the driving transistor T3. Specifically, during the light emission stage, the light-emitting element 110 emits light, and the illumination and rising temperature affect the voltage at the first node N1 connected to the driving transistor T3, causing the potential of the gate of the driving transistor T3 to rise. Furthermore, during the light emission stage, the driving transistor T3 works in an unsaturated state, and the voltage of the drain of the driving transistor T3 is less than the voltage of the gate of the driving transistor T3. As a result, the driving transistor T3 being the PMOS is turned on while the voltage of the drain of the driving transistor T3 is less than the voltage of the gate of the driving transistor T3, and a voltage difference and a potential difference between the drain of the driving transistor T3 and the gate of the driving transistor T3 are large. Such a long-term behavior leads to polarization of ions in the driving transistor T3, causing the threshold voltage of the driving transistor T3 to continuously rise and the potential of the gate of the driving transistor T3 to rise. The driving current flowing to the light-emitting element 110 is reduced due to the forward bias of the driving transistor T3, and the brightness of the light-emitting element 110 is reduced.

In the present embodiment, when the driving transistor T3 is the PMOS, the potential of the first bias signal vgl1 is designed to be smaller than the potential at the fourth node N4 or smaller than 0 V, so that the potential of the gate of the driving transistor T3 can be pulled down.

In one or more embodiments, during the bias adjustment stage Fa, the threshold compensation transistor T4 is turned off, the first reset transistor T5 is turned off, and the first scanning terminal S1 provides the low-level signal to turn on the bias transistor T8. When the potential of the first bias signal vgl1 is less than the potential at the fourth node N4 or less than 0 V, the first bias signal vgl1 provided by the first signal terminal V1 is written to the fourth node N4 through the turned-on bias transistor T8 so that the potential at the fourth node N4 can be pulled down, and then the potential of the gate of the driving transistor T3 can be pulled down through the coupling of the first capacitor Cst, thereby reducing the voltage difference between the drain and the gate of the driving transistor T3. An increase amplitude of the potential of the gate of the driving transistor T3 in the light emission stage can be offset by a decrease amplitude of the potential of the gate of the driving transistor T3 during the bias adjustment stage, the rise of the potential of the gate of the driving transistor T3 caused by the forward bias can be reduced or even eliminated, thus improving the working stability and driving current stability of the driving transistor T3, the gate voltage stability of the driving transistor T3, and the brightness of the light-emitting element 110, thereby improving the display brightness uniformity and display effect of the display panel.

In one or more embodiments, as shown in FIG. 3, the driving transistor T3 is the NMOS, and the potential of the first bias signal is higher than the potential at the fourth node N4. Alternatively, the driving transistor T3 is the NMOS, and the potential of the first bias signal is greater than 0 V.

The working process of the pixel circuit 120 includes the light emission stage. During the light emission stage, the driving transistor T3 is in the on state, and the driving transistor T3 provides the driving current for the light-emitting element 110 to enable the light-emitting element 110 to emit light.

For the driving transistor T3 being the NMOS, when the driving transistor T3 is in the on state, the potential of the gate of the driving transistor T3 is greater than the potential of the source of the driving transistor T3. In terms of the driving transistor T3 being the NMOS, the potential of the gate of the driving transistor T3 is equal to the potential at the first node N1, the potential of the drain is equal to the potential at the second node N2, and the potential of the source is equal to the potential at the third node N3. During the light emission stage, a forward bias occurs in the driving transistor T3. Specifically, during the light emission stage, the voltage of the drain of the driving transistor T3 is approximately equal to the potential of the first power signal of the first power terminal PVDD. As a result, the driving transistor T3 being the NMOS is turned on while the voltage of the drain of the driving transistor T3 is greater than the voltage of the gate of the driving transistor T3, and the voltage difference and the potential difference between the drain of the driving transistor T3 and the gate of the driving transistor T3 are large. Such a long-term behavior leads to polarization of ions in the driving transistor T3, causing the threshold voltage of the driving transistor T3 to continuously rise. The driving current flowing to the light-emitting element 110 is reduced due to the forward bias of the driving transistor T3, and thus the brightness of the light-emitting element 110 is reduced.

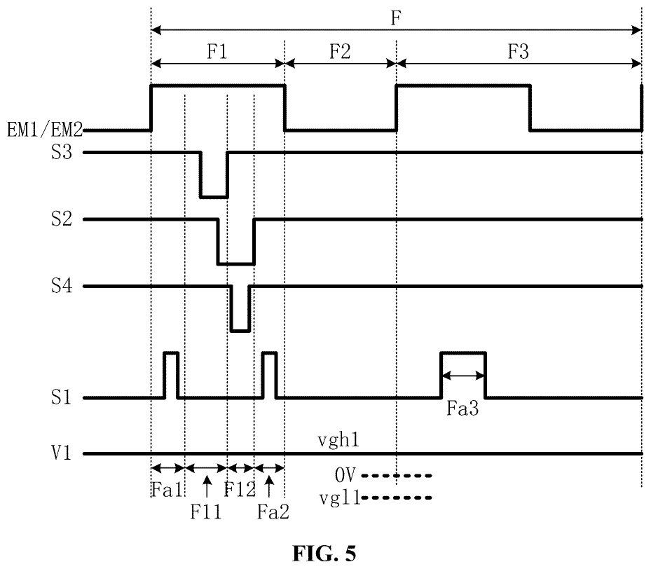

FIG. 5 is a working timing diagram of the pixel circuit shown in FIG. 3. In the present embodiment, when the driving transistor T3 is the NMOS, the potential of the first bias signal vgh1 is designed to be greater than the potential at the fourth node N4 or greater than 0 V so that the potential of the gate of the driving transistor T3 can be pulled up.

In one or more embodiments, during the bias adjustment stage Fa1, the threshold compensation transistor T4 is turned off, the first reset transistor T5 is turned off, and the first scanning terminal S1 provides a high-level signal to turn on the bias transistor T8. When the potential of the first bias signal vgh1 is greater than the potential at the fourth node N4 or greater than 0 V, the first bias signal vgh1 provided by the first signal terminal V1 is written to the fourth node N4 through the turned-on bias transistor T8 so that the potential at the fourth node N4 can be pulled up, and then the potential of the gate of the driving transistor T3 can be pulled up through the coupling of the first capacitor Cst, thereby reducing the voltage difference between the drain and the gate of the driving transistor T3, and reducing the bias level of the driving transistor T3. In this way, the working stability and driving current stability of the driving transistor T3 and the brightness of the light-emitting element 110 are improved; and thus the display brightness uniformity and display effect of the display panel are improved.

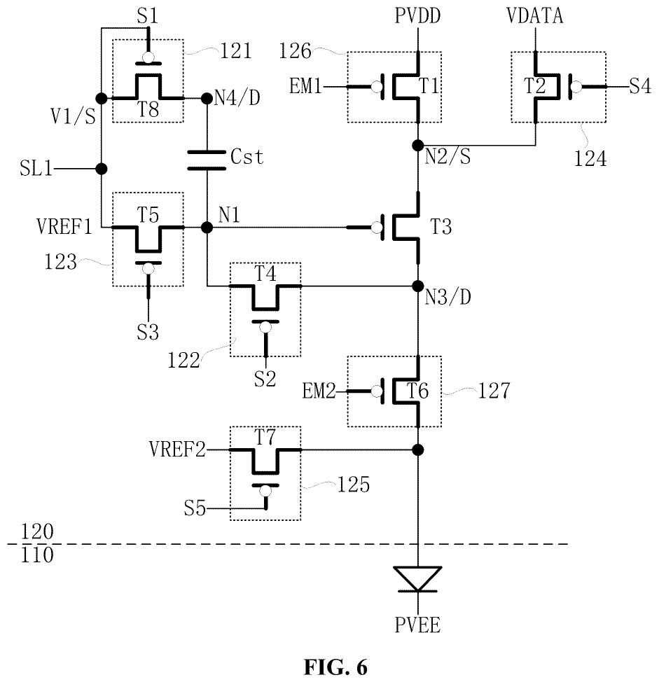

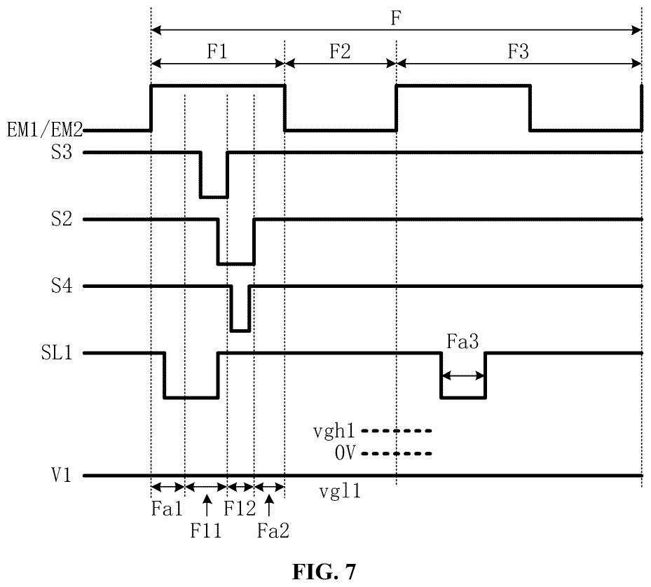

FIG. 6 is a schematic diagram of another pixel circuit provided by an embodiment of the present disclosure. FIG. 7 is a working timing diagram of the pixel circuit shown in FIG. 6. In one or more embodiments, as shown in FIGS. 6 and 7, the bias transistor T8 is the PMOS. The source S of the bias transistor T8 is electrically connected to the first signal terminal V1, and the drain D of the bias transistor T8 is electrically connected to the fourth node N4. In one or more embodiments, the display panel includes multiple signal lines including a first scanning line SL1. The first scanning terminal S1 and the first signal terminal V1 are electrically connected to the first scanning line SL1. In one or more embodiments, the display panel includes multiple signal lines including a first reset signal line (same as SL1). The first reset signal terminal VREF1 and the first signal terminal V1 are electrically connected to the first reset signal line SL1.

A display area AA of the display panel is used to present image content. The pixel circuits 120 and the light-emitting elements 110 are densely disposed in the display area AA. The pixel circuit 120 includes multiple transistors. Therefore, a wiring space left in the display area AA for signal lines is extremely limited.

In the present embodiment, when the bias transistor T8 is the PMOS, the gate and the source S of the bias transistor T8 are electrically connected so that the signal of the same first scanning line SL1 is transmitted to the first signal terminal V1 and the first scanning terminal S1. Further, the signal of the same first scanning line SL1 is transmitted to the first signal terminal V1, the first scanning terminal S1 and the first reset signal terminal VREF1.

As shown in FIGS. 6 and 7, during the bias adjustment stage Fa1, the first reset transistor T5 is turned off, and the first scanning line SL1 provides a low-level signal to turn on the bias transistor T8. The low-level signal provided by the first scanning line SL1 is written to the fourth node N4 through the turned-on bias transistor T8 so that the potential at the fourth node N4 can be pulled down, and then the gate potential of the driving transistor T3 can be pulled down through the coupling of the first capacitor Cst, thereby reducing or even eliminating the rise of the potential of the gate of the driving transistor T3 caused by the forward bias, and performing the adjustment on the bias state of the driving transistor T3. The illumination and temperature generated by the light-emitting element 110 cause the forward bias of the driving transistor T3 and the threshold compensation transistor T4, and lead to the variation of the voltage of the gate of the driving transistor T3. During this stage, the bias transistor T8 is turned on, and the potential at the fourth node N4 is adjusted by the bias of the bias transistor T8 itself, so that the potential V_{N4} at the fourth node N4 is equal to VREF1+|Vth_{T8}|. A gate-source voltage Vgs of the bias transistor T8 is Vth_{T8}. The voltage of the first node N1 drops with a voltage drop of the fourth node N4 so that a voltage rise of the first node N1 caused by the forward bias of the driving transistor T3 and the threshold compensation transistor T4 can be offset. In other words, the influence of the bias of the driving transistor T3 and the bias of the threshold compensation transistor T4 on the first node N1 can be compensated by an influence of the bias of the bias transistor T8 itself on the first node N1, and the driving current provided by the driving transistor T3 for the light-emitting element 110 can be stabilized and the brightness of the light-emitting element 110 can be improved.

During the initialization stage F11, the third scanning terminal S3 provides a low-level signal to turn on the first reset transistor T5, and the low-level signal provided by the first scanning line SL1 is written to the gate of the driving transistor T3 through the first reset transistor T5 to turn on the driving transistor T3. Similarly, the low-level signal provided by the first scanning line SL1 enables the bias transistor T8 to be turned on, and the low-level signal provided by the first scanning line SL1 is written to the fourth node N4 through the turned-on bias transistor T8, so that the potential of the gate of the driving transistor T3 can be pulled down to turn on the driving transistor T3, and the gate of the driving transistor T3 is reset.

As described above, the first scanning terminal S1, the first signal terminal V1 and the first reset signal terminal VREF1 being electrically connected to the same signal line SL1 can reduce the number of signal lines of the pixel circuit 120 without affecting the normal operation of the pixel circuit 120, and also release more space in the display area for the pixel circuit 120 and the light-emitting element 110, thereby improving the resolution of the display panel, reducing the number of signal lines in the display area AA, further reducing the interference of signal lines in the display area AA on the light transmittance, and improving the display quality.

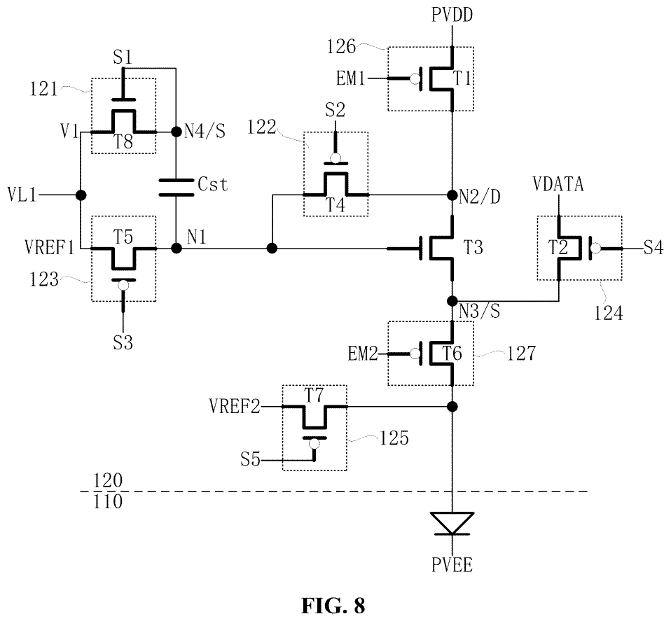

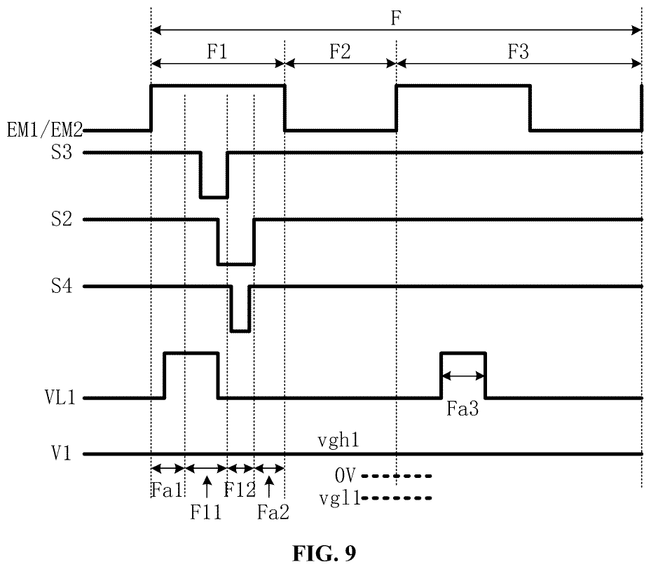

FIG. 8 is a schematic diagram of another pixel circuit provided by an embodiment of the present disclosure. FIG. 9 is a working timing diagram of the pixel circuit shown in FIG. 8. In one or more embodiments, as shown in FIGS. 8 and 9, the bias transistor T8 is the NMOS. The source S of the bias transistor T8 is electrically connected to the fourth node N4, and the drain D of the bias transistor T8 is electrically connected to the first signal terminal V1. In one or more embodiments, the first scanning terminal S1 is electrically connected to the fourth node N4. In one or more embodiments, the display panel includes multiple signal lines including a first reset signal line VL1. The first reset signal terminal VREF1 and the first signal terminal V1 are electrically connected to the first reset signal line VL1.

In the present embodiment, when the bias transistor T8 is the NMOS, the gate and the source S of the bias transistor T8 are electrically connected so that the on or off state of the bias transistor T8 is controlled by the potential at the fourth node N4. Further, the signal of the same signal line VL1 is transmitted to the first signal terminal V1 and the first reset signal terminal VREF1.

As shown in FIGS. 8 and 9, during the bias adjustment stage Fa1, the first reset transistor T5 is turned off, and the fourth node N4 provides a high-level signal to turn on the bias transistor T8. The high-level signal provided by the signal line VL1 is written to the fourth node N4 through the turned-on bias transistor T8 so that the potential at the fourth node N4 can be pulled up, and then the gate potential of the driving transistor T3 can be pulled up through the coupling of the first capacitor Cst, thereby reducing the bias level of the driving transistor T3 and achieving the adjustment on the bias state of the driving transistor T3.

During the initialization stage F11, the third scanning terminal S3 provides a low-level signal to turn on the first reset transistor T5, and the high-level signal provided by the signal line VL1 is written to the gate of the driving transistor T3 through the first reset transistor T5 to turn on the driving transistor T3. Similarly, the high-level signal provided by the signal line VL1 is written to the fourth node N4 through the turned-on bias transistor T8 so that the driving transistor T3 can be turned on and the gate of the driving transistor T3 can be reset.

As described above, the first signal terminal V1 and the first reset signal terminal VREF1 being electrically connected to the same signal line VL1 can reduce the number of signal lines of the pixel circuit 120 without affecting the normal operation of the pixel circuit 120, and also release more space in the display area for the pixel circuit 120 and the light-emitting element 110, thereby improving the resolution of the display panel, reducing the number of signal lines in the display area AA and the interference of signal lines on light transmittance in the display area AA, and improving the display quality.

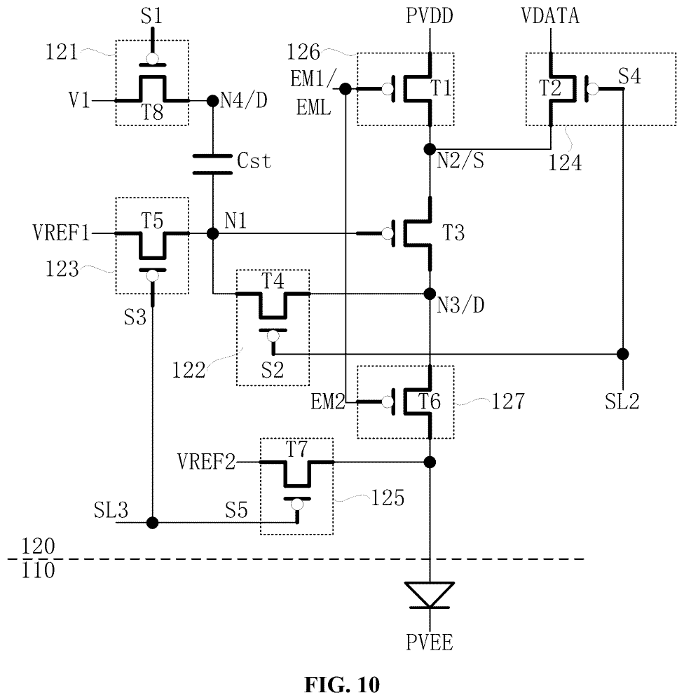

FIG. 10 is a schematic diagram of another pixel circuit provided by an embodiment of the present disclosure. In one or more embodiments, as shown in FIG. 10, the threshold compensation transistor T4 and the data write transistor T2 are each the PMOS. Alternatively, in some other embodiments, the threshold compensation transistor and the data write transistor are each the NMOS. In one or more embodiments, on this basis, the display panel includes multiple signal lines including a second scanning line SL2. The second scanning terminal S2 and the fourth scanning terminal S4 are electrically connected to the second scanning line SL2.

In the present embodiment, the threshold compensation transistor T4 and the data write transistor T2 are simultaneously turned on or off. Specifically, during the data write stage, the threshold compensation transistor T4 and the data write transistor T2 are simultaneously turned on. In one or more embodiments, during the initialization stage, the threshold compensation transistor T4 and the data write transistor T2 are simultaneously turned off. Apparently, the second scanning terminal S2 and the fourth scanning terminal S4 are electrically connected to the same signal line SL2, which can reduce the number of signal lines of the pixel circuit 120 without affecting the normal operation of the pixel circuit 120 and improve the resolution of the display panel, thereby reducing the interference of signal lines on the light transmittance in the display area AA, and improving the display quality.

In one or more embodiments, as shown in FIG. 10, the anode reset transistor T7 and the first reset transistor T5 are each the PMOS. Alternatively, in some other embodiments, the anode reset transistor and the first reset transistor are each the NMOS. In one or more embodiments, on this basis, the display panel includes multiple signal lines including a third scanning line SL3. The third scanning terminal S3 and the fifth scanning terminal S5 are electrically connected to the third scanning line SL3.

In the present embodiment, the anode reset transistor T7 and the first reset transistor T5 are simultaneously turned on or off. Specifically, during the initialization stage, the anode reset transistor T7 and the first reset transistor T5 are simultaneously turned on. In one or more embodiments, during the data write stage, the anode reset transistor T7 and the first reset transistor T5 are simultaneously turned off. Apparently, the third scanning terminal S3 and the fifth scanning terminal S5 are electrically connected to the same signal line SL3, which can reduce the number of signal lines of the pixel circuit 120 without affecting the normal operation of the pixel circuit 120, and improve the resolution of the display panel, thereby reducing the interference of signal lines on the light transmittance in the display area AA, and improving the display quality.

In one or more embodiments, as shown in FIG. 10, the display panel includes multiple signal lines including a dimming signal line EML. The first dimming control terminal EM1 and the second dimming control terminal EM2 are electrically connected to the dimming signal line EML.

In the present embodiment, the first dimming transistor T1 and the second dimming transistor T6 are simultaneously turned on or off. Specifically, during the pre-stage, the first dimming transistor T1 and the second dimming transistor T6 are simultaneously turned off. During the light emission stage, the first dimming transistor T1 and the second dimming transistor T6 are simultaneously turned on. Apparently, the first dimming control terminal EM1 and the second dimming control terminal EM2 are electrically connected to the same signal line EML, which can reduce the number of signal lines of the pixel circuit 120 without affecting the normal operation of the pixel circuit 120, and improve the resolution of the display panel, thereby reducing the interference of signal lines on the light transmittance in the display area AA, and improving the display quality.

It can be understood that the structure and timing of the pixel circuit in the present disclosure include but are not limited to the above examples. The pixel structure may be adaptively adjusted and the corresponding timing may be changed accordingly. For example, the bias transistor T8 is the NMOS and the driving transistor T3 is the PMOS, but it is not limited to this.

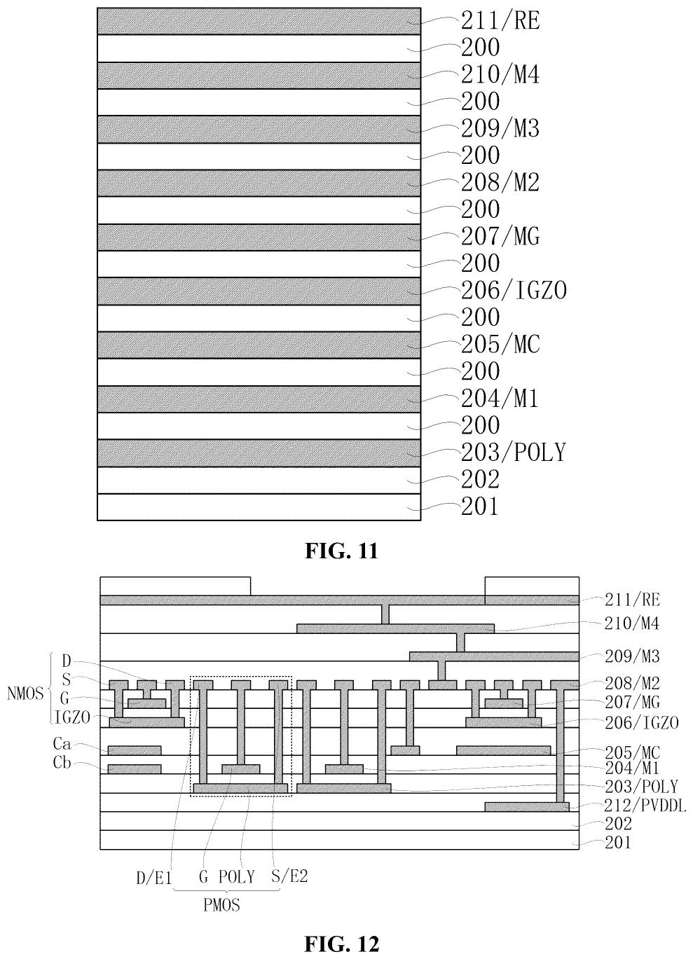

FIG. 11 is a schematic diagram of another display panel provided by an embodiment of the present disclosure. FIG. 12 is a schematic diagram of another display panel provided by an embodiment of the present disclosure. As shown in FIGS. 11 and 12, the display panel is formed by multiple films in a stacking manner. To clearly understand the specific arrangement positions of films, different films in the display panel are illustrated one by one from bottom to top. The multi-layer films of the display panel at least include a substrate 201 and a buffer layer 202, and the films on one side of the buffer layer 202 facing away from the substrate 201 in the display panel further include a first semiconductor layer (POLY) 203, a first metal layer (M1) 204, a second metal layer (MC) 205, a second semiconductor layer (IGZO) 206, a first gate layer (MG) 207, a third metal layer (M2) 208, a fourth metal layer (M3) 209, a fifth metal layer (M4) 210, and the film (RE) 211 where the anode of the light-emitting element 110 is located. It should be noted that an insulating film 200 exists between adjacent metal films. Based on the specific film arrangement of the display panel, adaptive adjustment may be made according to actual production requirements, such as adding or removing some films, which is not limited in the embodiments of the present disclosure.

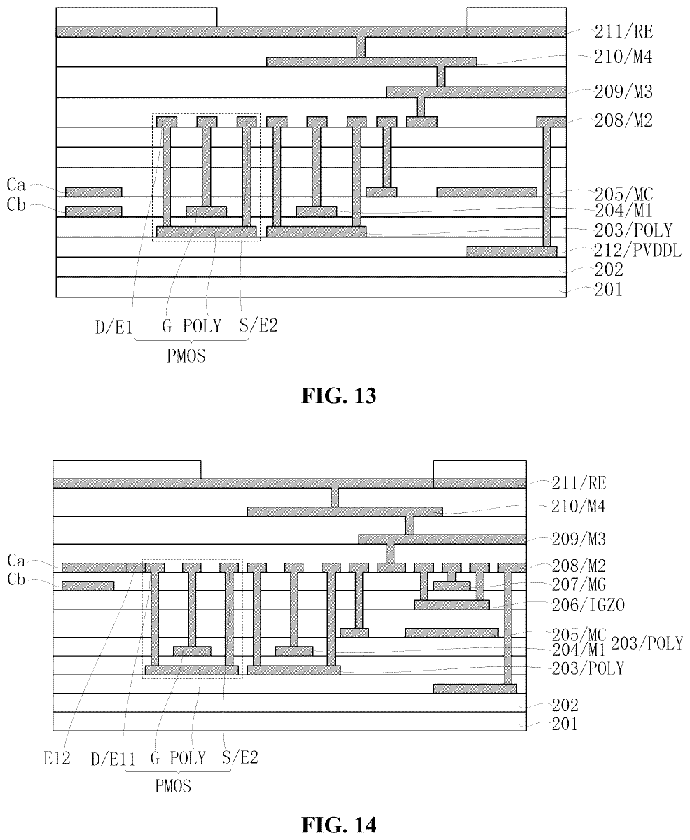

FIG. 13 is a schematic diagram of another display panel provided by an embodiment of the present disclosure. In one or more embodiments, the transistors in the pixel circuit may be each the PMOS, and accordingly, the display panel may not include the second semiconductor layer (IGZO) 206. In one or more embodiments, as shown in FIGS. 11 and 13, the multi-layer films of the display panel include at least a substrate 201 and a buffer layer 202, and the films on one side of the buffer layer 202 facing away from the substrate 201 further includes a first semiconductor layer (POLY) 203, a first metal layer (M1) 204, a second metal layer (MC) 205, a third metal layer (M2) 208, a fourth metal layer (M3) 209, a fifth metal layer (M4) 210 and the film (RE) 211 where the anode of the light-emitting element 110 is located. It should be noted that an insulating film 200 exists between adjacent metal films. Based on the specific film arrangement of the display panel, adaptive adjustment may be made according to actual production requirements, such as adding or removing some films, which is not limited in the embodiment of the present disclosure.

In the present embodiment, the structure of the display panel shown in FIG. 12 is taken as an example. In one or more embodiments, the first semiconductor layer (POLY) 203 is a silicon semiconductor layer, i.e., a low temperature poly-silicon semiconductor (POLY) layer. An active layer is formed in the first semiconductor layer (POLY) 203, and a gate G, a source S, and a drain D are formed in the multiple metal layers above the first semiconductor layer (POLY) 203 to form a PMOS. The second semiconductor layer (IGZO) 206 is an oxide semiconductor layer, i.e., a metal oxide semiconductor (IGZO) layer. An active layer is formed in the second semiconductor layer (IGZO) 206, and a gate G, a source S, and a drain D are formed in the multiple metal layers above the second semiconductor layer (IGZO) 206 to form an NMOS.

In one or more embodiments, the display panel includes a first semiconductor layer 203, a second semiconductor layer 206, and multiple metal layers. The bias transistor includes a first active layer, a first gate and a first source-drain, where the first source-drain is located at one side of the first gate facing away from the first active layer. The driving transistor includes a second active layer, a second gate and a second source-drain, where the second source-drain is located at one side of the second gate facing away from the second active layer. The first active layer is located in the first semiconductor layer or the second semiconductor layer. The second active layer is located in the first semiconductor layer or the second semiconductor layer. The first gate is located in one of the multiple metal layers, and the first source-drain is located in one of the multiple metal layers. The second gate is located in one of the multiple metal layers, and the second source-drain is located in one of the multiple metal layers. The first capacitor includes a first plate and a second plate disposed opposite to each other, and the first plate and the second plate are located in two of the multiple metal layers, respectively. The first source-drain includes a first electrode and a second electrode, the first electrode is electrically connected to the first plate, and the second electrode is electrically connected to the first signal terminal. In one or more embodiments, one of the first active layer and the second active layer includes a silicon semiconductor and the other one includes an oxide semiconductor.

Referring to FIGS. 2 and 12, in one or more embodiments, when the bias transistor T8 and the driving transistor T3 are each the PMOS, the first active layer of the bias transistor T8 and the second active layer of the driving transistor T3 are disposed in the same layer and are both located in the first semiconductor layer 203, the first gate of the bias transistor T8 and the second gate of the driving transistor T3 are disposed in the same layer and are both located in the first metal layer (M1) 204, and the first source-drain of the bias transistor T8 and the second source-drain of the driving transistor T3 are disposed in the same layer and are both located in the third metal layer (M2) 208. The first capacitor Cst includes a first plate Ca and a second plate Cb disposed oppositely. In one or more embodiments, the first plate Ca is located in the second metal layer (MC) 205, and the second plate Cb is located in the first metal layer (M1) 204. The first source-drain of the bias transistor T8 includes a first electrode E1 and a second electrode E2. In one or more embodiments, the first electrode E1 as the drain D is electrically connected to the first plate Ca, and the second electrode E2 as the source S is electrically connected to the first signal terminal V1.

FIG. 14 is a schematic diagram of another display panel provided by an embodiment of the present disclosure. In one or more embodiments, as shown in FIG. 14, the first source-drain and the first plate Ca are disposed in the same layer. In one or more embodiments, as shown in FIG. 14, the first electrode E1 includes a first electrode body E11 and a first electrode connecting part E12 connected to the first electrode body E11. The first electrode body E11 is electrically connected to the first plate Ca through the first electrode connecting part E12, and the area of the first electrode body E11 is larger than the area of the first electrode connecting part E12. In one or more embodiments, referring to FIG. 14, the first electrode E1 includes the first electrode body E11 and the first electrode connecting part E12 connected to the first electrode body E11. The first electrode connecting part E12 serves as the first plate Ca.

In one or more embodiments, the first source-drain of the bias transistor T8 is located in the third metal layer (M2) 208, and the first plate Ca is located in the third metal layer (M2) 208. In one or more embodiments, the second plate Cb is located in the first gate layer (MG) 207, but it is not limited to this. The first electrode E1 of the first source-drain is electrically connected to the first plate Ca disposed in the same layer. The area of the first electrode E1 may be relatively large so that the first electrode body E11 of the first electrode E1 is electrically connected to the first active layer, and the first electrode connecting part E12 of the first electrode E1 is electrically connected to the first plate Ca disposed in the same layer. Alternatively, the first electrode connecting part E12 also serves as the first plate Ca so that the first electrode E1 is electrically connected to the first plate Ca disposed in the same layer.

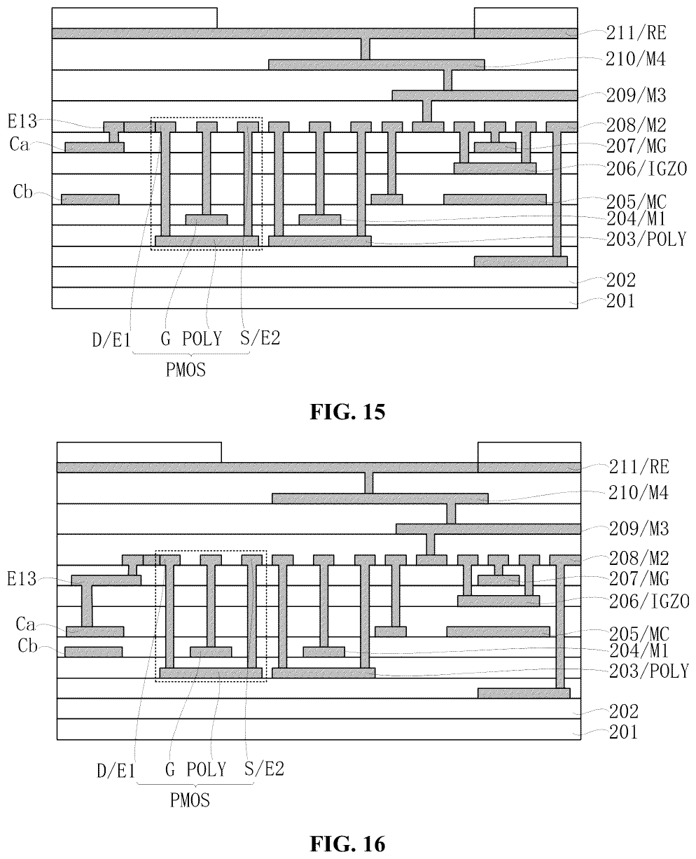

FIG. 15 is a schematic diagram of another display panel provided by an embodiment of the present disclosure. In one or more embodiments, as shown in FIG. 15, the first source-drain and the first plate Ca are disposed in different layers, and the first electrode E1 is electrically connected to the first plate Ca through a first transition part E13. In one or more embodiments, the first transition part E13 extends along the thickness direction of the display panel, and the first transition part E13 is electrically connected to the first electrode E1 and the first plate Ca through a via.

In one or more embodiments, the first source-drain of the bias transistor T8 is located in the third metal layer (M2) 208, and the first transition part E13 and the first source-drain are disposed in the same layer and are both located in the third metal layer (M2) 208. In one or more embodiments, the first plate Ca is located in the first gate layer (MG) 207, and the second plate Cb is located in the second metal layer (MC) 205, but it is not limited to this. The first transition part E13 is electrically connected to the first plate Ca in a different layer through a via, so the first transition part E13 in the same layer as the first electrode E1 is electrically connected to the first plate Ca in a different layer by drilling a via, thus enabling the first electrode E1 to be electrically connected to the first plate Ca in a different layer.

FIG. 16 is a schematic diagram of another display panel provided by an embodiment of the present disclosure. In one or more embodiments, as shown in FIG. 16, the metal layer where the first transition part E13 is located is between the first electrode E1 and the first plate Ca. The first transition part E13 is electrically connected to the first electrode E1 through a via, and the first transition part E13 is electrically connected to the first plate Ca through another via. In one or more embodiments, the second gate and the second plate are disposed in the same layer.

In one or more embodiments, the first source-drain of the bias transistor T8 is located in the third metal layer (M2) 208, the first transition part E13 and the first source-drain are in different layers, and the first transition part E13 is located in the first gate layer (MG) 207. In one or more embodiments, the first plate Ca is located in the second metal layer (MC) 205, and the second plate Cb and the second gate of the driving transistor T3 are located in the first metal layer (M1) 204, but it is not limited to this. The first transition part E13 and the first source-drain are disposed in different layers, and the first transition part E13 and the first plate Ca are disposed in different layers. In this case, the first transition part E13 is electrically connected to the first electrode E1 through a via and electrically connected to the first plate Ca through another via. Therefore, the first electrode E1 of the first source-drain is electrically connected to the first transition part E13 in a different layer by drilling a via, and then the first transition part E13 is electrically connected to the first plate Ca in a different layer by drilling another via; thus the first electrode E1 can be electrically connected to the first plate Ca in a different layer.

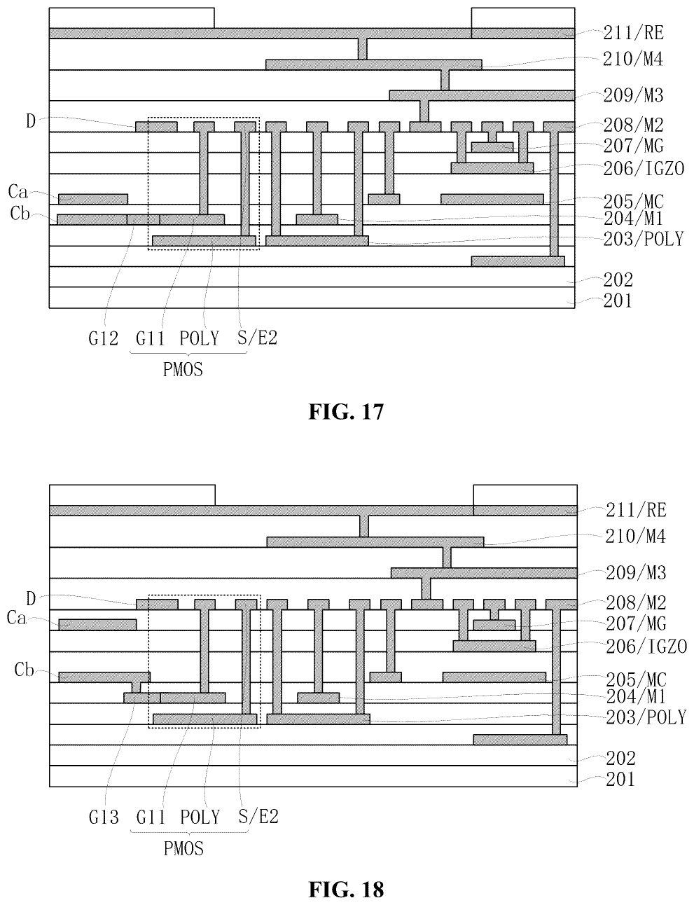

FIG. 17 is a schematic diagram of another display panel provided by an embodiment of the present disclosure. In one or more embodiments, as shown in FIG. 17, the second gate G and the second plate Cb are disposed in the same layer. The second gate G includes a second gate body G11 and a second gate connecting part G12 connected to the second gate body G11. The second gate body G11 is electrically connected to the second plate Cb through the second gate connecting part G12, and the area of the second gate body G11 is larger than the area of the second gate connecting part G12. In one or more embodiments, the second gate G includes a second gate body G11 and a second gate connecting part G12 connected to the second gate body G11, and the second gate connecting part G12 serves as the second plate Cb.

In one or more embodiments, the second gate of the driving transistor T3 is located in the first metal layer (M1) 204, the second gate G and the second plate Cb are disposed in the same layer, and the second plate Cb is located in the first metal layer (M1) 204. The second gate G of the driving transistor T3 is electrically connected to the second plate Cb disposed in the same layer, and the area of the second gate G may be relatively large, where the second gate body G11 of the second gate G serves as the gate of the driving transistor T3, the second gate connection part G12 of the second gate G is electrically connected to the second plate Cb disposed in the same layer; or the second gate connection part G12 also serves as the second plate Cb. In this manner, the gate G of the driving transistor T3 is electrically connected to the second plate Cb of the first capacitor Cst disposed in the same layer.

FIG. 18 is a schematic diagram of another display panel provided by an embodiment of the present disclosure. In one or more embodiments, as shown in FIG. 18, the second gate G of the driving transistor T3 and the second plate Cb are disposed in different layers, and the second gate G is electrically connected to the second plate Cb through the second transition part G13. In one or more embodiments, the second transition part G13 extends along the thickness direction of the display panel, and the second transition part G13 is electrically connected to the second gate G and the second plate Cb through a via.

In one or more embodiments, the second gate G of the driving transistor T3 is located in the first metal layer (M1) 204, and the second transition part G13 and the second gate G are disposed in the same layer. In one or more embodiments, the second plate Cb is located in the second metal layer (MC) 205, and the second transition part G13 is electrically connected to the second plate Cb in a different layer through a via, so that the second transition part G13 in the same layer as the second gate G of the driving transistor T3 is electrically connected to the second plate Cb in a different layer by drilling a via. In this manner, the second gate G of the driving transistor T3 is electrically connected to the second plate Cb in a different layer.

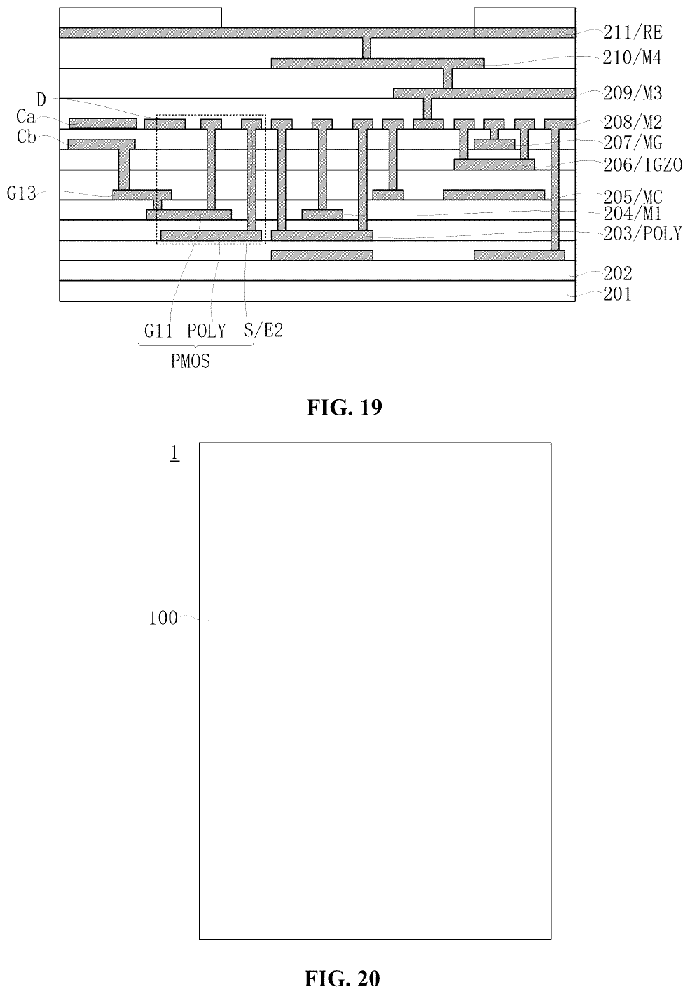

FIG. 19 is a schematic diagram of another display panel provided by an embodiment of the present disclosure. In one or more embodiments, as shown in FIG. 19, the metal layer where the second transition part G13 is located is between the second gate G of the driving transistor T3 and the second plate Cb, and the second transition part G13 is electrically connected to the second gate G of the driving transistor T3 through a via and connected to the second plate Cb through another via.

In one or more embodiments, the second gate G of the driving transistor T3 is located in the first metal layer (M1) 204, the second gate G of the driving transistor T3 and the second transition part G13 are disposed in different layers, and the second transition part G13 is located in the second metal layer (MC) 205. In one or more embodiments, the second plate Cb is located in the first gate layer (MG) 207. The second transition part G13 is electrically connected to the second gate G of the driving transistor T3 in a different layer through a via, and the second plate Cb is electrically connected to the second transition part G13 in a different layer through a via, so that the second gate G of the driving transistor T3 is electrically connected to the second plate Cb through drilling the via.

In the above-mentioned embodiments, the bias transistor T8 and the driving transistor T3 may each be the PMOS. Therefore, only partial arrangement of the bias transistor T8 and the first plate Ca and the second plate Cb of the first capacitor Cst is shown. On the basis that the drain D of the bias transistor T8 is electrically connected to the first plate Ca of the first capacitor Cst and the second gate of the driving transistor T3 is electrically connected to the second plate Cb of the first capacitor Cst, the films where the first plate Ca and the second plate Cb of the first capacitor Cst are located may be flexibly designed, which are not limited to the above embodiments.

In some other embodiments, the bias transistor T8 may be the NMOS, then the source S of the bias transistor T8 is electrically connected to the first plate Ca of the first capacitor Cst. In one or more embodiments, the driving transistor T3 may be the NMOS, the second gate G of the driving transistor T3 and the first gate layer (MG) 207 are disposed in the same layer, and the second gate G of the driving transistor T3 is electrically connected to the second plate Cb of the first capacitor Cst. Therefore, the films where the first plate Ca and the second plate Cb of the first capacitor Cst are located may be flexibly designed, which are not limited to the above embodiments.

In one or more embodiments, referring to FIG. 12, the multiple metal layers include a first power metal layer 212 including multiple first power lines PVDDL. Along the thickness direction of the display panel, the second gate does not overlap the first power lines PVDDL. In one or more embodiments, a first power line PVDDL may include multiple first power parts, and a first power part is used as the first power terminal PVDD.

In the present embodiment, if the driving transistor T3 is the PMOS, the second gate G of the driving transistor T3 is located in the first metal layer (M1) 204, and the first power lines PVDDL in the first power metal layer 212 do not overlap the second gate G of the driving transistor T3; correspondingly, no interference between the first power lines PVDDL and the second gate G of the driving transistor T3 is generated.

If the driving transistor T3 is the NMOS, the second gate G of the driving transistor T3 is located in the first gate layer (MG) 207, and the first power line PVDDL in the first power metal layer 212 does not overlap the second gate G of the driving transistor T3; correspondingly, no interference between the first power lines PVDDL and the second gate G of the driving transistor T3 is generated.

As described above, the first power lines PVDDL do not overlap the second gate G of the driving transistor T3, and no electrical interference between the first power lines PVDDL and the second gate G is generated, so that the bias state of the driving transistor T3 can be conveniently adjusted by using the bias state of the bias transistor T8, thus improving the working stability and gate voltage stability of the driving transistor T3 and alleviating the drift of the threshold voltage of the driving transistor T3. In this way, the stability of the driving current provided by the driving transistor T3 for the light-emitting element is improved, so that the display uniformity of the display panel and the image display effect of the display panel can be improved.

In one or more embodiments, the multiple metal layers include a third transition metal layer, and the third transition metal layer includes multiple third transition parts. The third transition parts are the first power terminals. Along the thickness direction of the display panel, the second gate does not overlap the third transition parts. In one or more embodiments, the multiple metal layers include a fourth transition metal layer, and the fourth transition metal layer includes multiple fourth transition parts. The fourth transition parts are electrically connected to the second gate. Along the thickness direction of the display panel, the first power lines do not overlap the fourth transition parts.

In the present embodiment, if the first power line PVDDL is electrically connected to the first power terminal through the third transition part, the potential of the first power line PVDDL is the same as the potential of the third transition part. If the second gate of the driving transistor T3 is electrically connected to the fourth transition part, the potential of the second gate of the driving transistor T3 is the same as the potential of the fourth transition part. Along the thickness direction of the display panel, the second gate of the driving transistor T3 does not overlap the third transition part, and the first power line PVDDL does not overlap the fourth transition part of the second gate of the driving transistor T3, thus ensuring that the first power terminal PVDD in the pixel circuit 120 does not overlap the second gate of the driving transistor T3. In this manner, no interference between the first power line PVDDL and the second gate G of the driving transistor T3 is generated. The bias state of the driving transistor T3 can be conveniently adjusted by using the bias state of the bias transistor T8, thus improving the working stability and gate voltage stability of the driving transistor T3 and alleviating the drift of the threshold voltage of the driving transistor T3. In this way, the stability of the driving current provided by the driving transistor T3 for the light-emitting element is improved so that the display uniformity of the display panel and the image display effect of the display panel can be improved.

Based on the same inventive concept, an embodiment of the present disclosure further provides a display device. The display device includes any display panel provided by the above embodiment. FIG. 20 is a schematic diagram of a display device provided by an embodiment of the present disclosure. As shown in FIG. 20, the display device 1 includes a display panel 100. Therefore, the display device 1 also has the beneficial effects of the display panel 100 in the above embodiment. The similarities can be understood with reference to the above explanation of the display panel, which will not be repeated below.

The display device 1 provided by the embodiment of the present disclosure may be a mobile phone as shown in FIG. 20, or may be any electronic product with a display function, including but not limited to the following categories: television, notebook computer, desktop display, tablet computer, digital camera, smart bracelet, smart glasses, in-vehicle display, industrial control equipment, medical display screen, touch interactive terminal, etc. The embodiment of the present disclosure does not make any special restrictions on this.

It should be understood that steps may be reordered, added or deleted using the various forms of the processes shown above. For example, the steps described in the present disclosure may be executed in parallel, sequentially or in a different order, as long as the desired result of the technical solution of the present disclosure can be achieved. This is not limited herein.

The above specific embodiments do not limit the scope of protection of the present disclosure. Those skilled in the art will appreciate that various modifications, combinations, sub-combinations, and substitutions may be made based on design requirements and other factors. Any modification, equivalent substitution and improvement made within the spirit and principle of the present disclosure are within the protection scope of the present disclosure.

What is claimed is:

1. A display panel, comprising: a pixel circuit and a light-emitting element; wherein
the pixel circuit comprises a driving transistor, a bias adjustment module, a threshold compensation module and a first capacitor;
a gate of the driving transistor is electrically connected to a first node, a first electrode of the driving transistor is electrically connected to a second node, a second electrode of the driving transistor is electrically connected to a third node, the second node is electrically connected to a first power terminal, and the third node is electrically connected to the light-emitting element;
the bias adjustment module comprises a bias transistor, a gate of the bias transistor is electrically connected to a first scanning terminal, and the bias transistor is electrically connected between a first signal terminal and a fourth node; the first capacitor is electrically connected between the fourth node and the first node; the first signal terminal is configured to provide a first bias signal; and
a control terminal of the threshold compensation module is electrically connected to a second scanning terminal, and the threshold compensation module is electrically connected between the first node and the third node or between the first node and the second node.

2. The display panel according to claim 1, wherein the bias transistor is P-metal-oxide-semiconductor (PMOS);
a source of the bias transistor is electrically connected to the first signal terminal, and a drain of the bias transistor is electrically connected to the fourth node; and
the display panel comprises a plurality of signal lines comprising a first scanning line, wherein the first scanning terminal and the first signal terminal are electrically connected to the first scanning line.

3. The display panel according to claim 1, wherein the bias transistor is an N-metal-oxide-semiconductor (NMOS);
a source of the bias transistor is electrically connected to the fourth node, and a drain of the bias transistor is electrically connected to the first signal terminal; and
the first scanning terminal is electrically connected to the fourth node.

4. The display panel according to claim 1, wherein the pixel circuit further comprises a first reset module, wherein the first reset module comprises a first reset transistor, a gate of the first reset transistor is electrically connected to a third scanning terminal, and the first reset transistor is electrically connected between a first reset signal terminal and the first node; and
the display panel comprises a plurality of signal lines comprising a first reset signal line, wherein the first reset signal terminal and the first signal terminal are electrically connected to the first reset signal line.

5. The display panel according to claim 1, wherein the bias transistor is a double-gate transistor.

6. The display panel according to claim 1, wherein the driving transistor is a PMOS, and a potential of the first bias signal is smaller than a potential at the fourth node; or
wherein the driving transistor is a PMOS, and a potential of the first bias signal is less than 0 V.

7. The display panel according to claim 1, wherein the driving transistor is an NMOS, and a potential of the first bias signal is greater than a potential at the fourth node; or
wherein the driving transistor is an NMOS, and a potential of the first bias signal is greater than 0 V.

8. The display panel according to claim 1, wherein one of the following is satisfied:
a width-to-length ratio of the bias transistor is a first value, a width-to-length ratio of the driving transistor is a second value, and a difference between the first value and the second value is less than or equal to a preset difference;
a width-to-length ratio of the bias transistor is a first value, the threshold compensation module comprises a threshold compensation transistor, a width-to-length ratio of the threshold compensation transistor is a third value, and the first value is smaller than the third value;
a width-to-length ratio of the driving transistor is a second value, the threshold compensation module comprises a threshold compensation transistor, a width-to-length ratio of the threshold compensation transistor is a third value, and the second value is smaller than the third value; and
a width of the gate of the bias transistor is Wa, and a length of the gate of the bias transistor is La, the threshold compensation module comprises a threshold compensation transistor, wherein a width of a gate of the threshold compensation transistor is Wb, and a length of the gate of the threshold compensation transistor is Lb; and at least one of the following is satisfied: Wa≥Wb, or La≥Lb.

9. The display panel according to claim 1, wherein the pixel circuit further comprises a data write module;
wherein the data write module comprises a data write transistor, a gate of the data write transistor is electrically connected to a fourth scanning terminal, and the data write transistor is electrically connected between a data signal terminal and the second node or between a data signal terminal and the third node; and
during at least one frame time, a pre-stage of the pixel circuit comprises a data write stage and a bias adjustment stage, wherein
during the data write stage, the bias adjustment module is turned off and the data write module is turned on; and
during the bias adjustment stage, the bias transistor is turned on.

10. The display panel according to claim 9, wherein during the at least one frame time, the data write stage and the bias adjustment stage comprised in the pre-stage are executed sequentially; or
during the at least one frame time, the bias adjustment stage and the data write stage comprised in the pre-stage are executed sequentially.

11. The display panel according to claim 9, wherein during the at least one frame time, the bias adjustment stage comprises a first bias sub-stage and a second bias sub-stage, and the first bias sub-stage and the second bias sub-stage are executed with an interval between the first bias sub-stage and the second bias sub-stage; and
the data write stage in the pre-stage is between the first bias sub-stage and the second bias sub-stage.

12. The display panel according to claim 1, wherein the display panel comprises a first semiconductor layer, a second semiconductor layer and a plurality of metal layers;
the bias transistor comprises a first active layer, a first gate and a first source-drain, wherein the first source-drain is located at a side of the first gate facing away from the first active layer;
the driving transistor comprises a second active layer, a second gate and a second source-drain, wherein the second source-drain is located at a side of the second gate facing away from the second active layer;
the first active layer is located in the first semiconductor layer or the second semiconductor layer;
the second active layer is located in the first semiconductor layer or the second semiconductor layer;
the first gate is located in one metal layer among the plurality of metal layers, the first source-drain is located in one metal layer among the plurality of metal layers, the second gate is located in one metal layer among the plurality of metal layers, and the second source-drain is located in one metal layer among the plurality of metal layers;
the first capacitor comprises a first plate and a second plate disposed opposite to each other, and the first plate and the second plate are located in two metal layers among the plurality of metal layers; and
the first source-drain comprises a first electrode and a second electrode, wherein the first electrode is electrically connected to the first plate, and the second electrode is electrically connected to the first signal terminal.

13. The display panel according to claim 12, wherein one of the first active layer and the second active layer comprises a silicon semiconductor, and the other one of the first active layer and the second active layer comprises an oxide semiconductor.

14. The display panel according to claim 12, wherein the first source-drain and the first plate are disposed in a same layer.

15. The display panel according to claim 14, wherein the first electrode comprises a first electrode body and a first electrode connecting part connected to the first electrode body, wherein
the first electrode body is electrically connected to the first plate through the first electrode connecting part, and an area of the first electrode body is larger than an area of the first electrode connecting part; or
the first electrode connecting part serves as the first plate.

16. The display panel according to claim 12, wherein the first source-drain and the first plate are disposed in different layers, and the first electrode is electrically connected to the first plate through a first transition part.

17. The display panel according to claim 16, wherein the first transition part extends along a thickness direction of the display panel, the first transition part is electrically connected to the first electrode through a via, and the first transition part is electrically connected to the first plate through another via; or
wherein a metal layer where the first transition part is located is between the first electrode and the first plate, and the first transition part is electrically connected to the first electrode through a via and is electrically connected to the first plate through another via.

18. The display panel according to claim 12, wherein the plurality of metal layers comprise a first power metal layer, and the first power metal layer comprises a plurality of first power lines; and
along a thickness direction of the display panel, the second gate does not overlap the plurality of first power lines.

19. The display panel according to claim 18, wherein one of the following is satisfied:
the plurality of first power lines comprise a plurality of first power parts, and the plurality of first power parts are used as the first power terminal;
the plurality of metal layers comprise a third transition metal layer, and the third transition metal layer comprises a plurality of third transition parts, the plurality of third transition parts are used as the first power terminal, and along the thickness direction of the display panel, the second gate does not overlap the plurality of third transition parts; and
the plurality of metal layers comprise a fourth transition metal layer, and the fourth transition metal layer comprises a plurality of fourth transition parts, the plurality of fourth transition parts are electrically connected to the second gate, and along the thickness direction of the display panel, the plurality of first power lines and the plurality of fourth transition parts do not overlap.

20. A display device, comprising a display panel, wherein the display panel comprises a pixel circuit and a light-emitting element; wherein
the pixel circuit comprises a driving transistor, a bias adjustment module, a threshold compensation module and a first capacitor;
a gate of the driving transistor is electrically connected to a first node, a first electrode of the driving transistor is electrically connected to a second node, a second electrode of the driving transistor is electrically connected to a third node, the second node is electrically connected to a first power terminal, and the third node is electrically connected to the light-emitting element;
the bias adjustment module comprises a bias transistor, a gate of the bias transistor is electrically connected to a first scanning terminal, and the bias transistor is electrically connected between a first signal terminal and a fourth node; the first capacitor is electrically connected between the fourth node and the first node; the first signal terminal is configured to provide a first bias signal; and
a control terminal of the threshold compensation module is electrically connected to a second scanning terminal, and the threshold compensation module is electrically connected between the first node and the third node or between the first node and the second node.
